(19) United States
(12) Patent Application Publication
(10) Pub. No.: US 2007/0292135 A1
(43) Pub. Date: Dec. 20, 2007

(54) INTEGRATED REMOTE CONTROL SIGNALING

(76) Inventors: Yong Guo, Irvine, CA (US); Yu-Shian Lee, Placentia, CA (US); Mingcheng Xu, Simi Valley, CA (US); Shing-Wu P. Tzeng, Fountain Valley, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/423,381

(22) Filed: Jun. 9, 2006

(51) Int. Cl. H04B 10/00

(52) U.S. Cl. 398/106; 398/113; 340/825.72

(57) ABSTRACT

A serial transmission protocol and architecture are provided that can be used to forward remote control data between sink (e.g., DTV) and source (e.g., DVD player) devices, in addition to other data such as video and/or audio or other payload. The target device need not be in the line of sight of the remote control beam. Daisy-chained devices will pass the remote control signal to the appropriate target device, so that the user can point any remote control at the DTV or other conveniently located device in the system, and still control the actual target device. The communication channel that carries payload, processing control, and remote control data can be implemented with wired or wireless of technology (or a combination thereof). In one particular embodiment, the communication channel is implemented with a single fiber. A number of presentation and entertainment system applications that employ remote control technology (e.g., home theater, audio, and computer implemented systems) can benefit from embodiments of the present invention.

### RELATED APPLICATIONS

This application is related to U.S. application Ser. No. 11/406,558 filed Apr. 18, 2006, titled “Protocol for Uncompressed Multimedia Data Transmission.” This application is also related to U.S. application Ser. No. 11/406,875, filed Apr. 18, 2006, and titled “EDID Pass Through via Serial Channel.” Each of these applications is herein incorporated in its entirety by reference.

### FIELD OF THE INVENTION

The invention relates to communication systems, and more particularly, to a protocol for uncompressed multimedia data transmission.

### BACKGROUND OF THE INVENTION

Infrared (IR) remote controllers are widely used to control consumer appliances such as televisions, DVD players, satellite/cable setup boxes, and home theater systems. As is known, a remote control gives the consumer the convenience to control a target device. However, remote controls are associated with a number of problems, particularly when there are multiple pieces of equipment to be controlled and at least one piece is not in the user's forward field of view.

Consider, for example, a home entertainment system or media center application that includes a digital television (DTV) and a DVD player that is equipped with a remote control. Normally, the user simply points the remote control at the DVD player to control its functionality (e.g., play, pause, stop, etc). However, if the DTV is located in front of the user, and the DVD player is located behind the user (e.g., in the rack of a media center), then using the remote control becomes somewhat more involved.

In particular, the user has to point the remote control backward to the DVD player location. This is awkward in that the user has to divide his attention (at least to some extent) to both the DTV in front of him and the DVD player behind him. Moreover, many users intuitively point the remote control at the DTV in effort to control the DVD player. Unfortunately, aiming the remote control at the DTV will not control the DVD player behind the user, as the remote control operates on a line-of-sight basis and needs to be pointed at least in the general direction of the device of which it is intended to control.

One solution to this problem is to install an IR repeater circuit, which includes an IR receiver and an IR emitter. Typically, the IR receiver is installed proximate the TV in the user's field of view, and the IR emitter is installed in a location within sight of the device to be controlled (e.g., DVD player or VCR). A pair of copper wires connects the IR receiver to the IR emitter. However, such repeater techniques require dedicated circuitry and wiring therebetween, in addition to the componentry and cabling between the sink and source devices. Such additional circuitry and wiring add to undesirable clutter in the user's space.

What is needed are better remote control techniques.

### SUMMARY OF THE INVENTION

One embodiment of the present invention provides a method for communicating remote control information in a system including a source device and a sink device that are communicatively coupled by a serial communication link that includes a forward channel and a backward channel. The method includes detecting (at the sink device) infrared (IR) remote control signal data for the source device, and sampling the IR remote control signal data to form an electrical signal. The method further includes sending the electrical signal to the source device via the backward channel, wherein the forward channel can simultaneously carry payload data from the source device to the sink device. The backward channel can be implemented, for example, using a single fiber optic cable or a wireless transmission (e.g., radio frequency or optical), and the forward channel can be implemented using the same single fiber optic cable as the backward channel, or an optical wireless transmission. The method may include determining whether a start and/or end of remote control data signal have been received. In response to start of remote control data signal being received, starting the sampling and sending. In response to no end of remote control data signal being received, repeating the sampling and sending. In one particular case, the method includes determining (at the sink device) if IR data has been detected. In response to IR data being detected, the method includes determining if the detected IR data is valid IR remote control signal data, wherein sampling the IR remote control signal data is carried out in response to the detected IR data being valid IR remote control signal data. In another particular case, sampling the IR remote control signal data to form an electrical signal includes grouping IR remote control signal samples into a data packet, and sending the electrical signal to the source device includes sending the data packet to the source device. The method may include receiving (at the source device) the electrical signal, and controlling the source device in accordance with the IR remote control signal data represented by the electrical signal. In one such case, receiving the electrical signal includes determining if the electrical signal is corrupted, and in response to the electrical signal not being corrupted, the method further includes sending an acknowledgment (e.g., ACK packet) to the sink device via the forward channel. In response to the remote control data packet being corrupted, no acknowledgment is sent. Controlling the source device in accordance with the IR remote control signal data represented by the electrical signal may include regenerating the IR remote control signal data (to illuminate IR detector circuitry of the target device), or providing the electrical signal directly to remote control circuitry of the target device. In another particular case, the method includes sending an acknowledgment to the sink device via the forward channel, so as to acknowledge receipt of the electrical signal at the source device, and determining (at the sink device) whether an acknowledgment has been received within a pre-set time limit. In response to no acknowledgment being received within the pre-set time limit, the method may include re-sending the electrical signal. In one such case, the method further includes determining if a timeout has occurred. In response to a timeout, the method includes discarding the IR remote control signal data. In response to no timeout, the method includes repeating re-sending the electrical signal until either an acknowledgment is timely received or a timeout occurs. In another particular case, sampling the IR remote control signal data to form an electrical signal further includes recognizing a format associated with the IR remote control signal data, and extracting command data included in the IR remote control signal data specified by the format, wherein the command data is sampled to form the electrical signal. In another particular case, the method may include receiving (at the source device) the electrical signal, recognizing a remote control signal format associated with the electrical signal, and rebuilding a remote control signal pursuant to the format. In another particular case, the method may include receiving (at the source device) the electrical signal, and rebuilding a remote control signal pursuant to a known remote control signal format. In one such particular case, the method may further include providing the remote control signal to control circuitry of the source device. In another such particular case, the method includes converting the remote control signal to an IR signal and providing the IR signal to control circuitry of the source device.

Another embodiment of the present invention provides a system for communicating remote control information between a source device and a sink device that are communicatively coupled by a serial communication link that includes a forward channel and a backward channel. The system includes a sink-side infrared (IR) detector for detecting IR remote control signal data for the source device, and a sink-side control processor for sampling the IR remote control signal data to form an electrical signal. The system also includes a sink-side transmitter (e.g., a multiplexer or transmitting state machine or transceiver) for sending the electrical signal to the source device via the backward channel, wherein the forward channel can simultaneously carry payload data from the source device to the sink device. The backward channel can be implemented, for example, using a single fiber optic cable or a wireless transmission (e.g., radio frequency or optical), and the forward channel can be implemented using the same single fiber optic cable as the backward channel or an optical wireless transmission. The system may include a source-side receiver (e.g., a demultiplexer or receiving state machine or transceiver) for receiving the electrical signal, and a source-side remote control process for controlling the source device in accordance with the IR remote control signal data represented by the electrical signal. The system may include a source-side transmitter for sending an acknowledgment to the sink device via the forward channel, so as to acknowledge receipt of the electrical signal at the source device. Here, the sink-side control processor is further configured for determining whether an acknowledgment has been received within a pre-set time limit, and in response to no acknowledgment being received within the pre-set time limit, for causing the sink-side transmitter to re-send the electrical signal. The sink-side control processor may further be configured for determining whether a start of remote control data signal has been received, and in response to a start of remote control data signal being received, for causing the sampling and sending to be initiated. The sink-side control processor may further be configured for determining whether an end of remote control data signal has been received, and in response to no end of remote control data signal being received, for causing the sampling and sending to be repeated. The sink-side control processor may be adapted to recognize a format associated with the IR remote control signal data, and to extract command data included in the IR remote control signal data specified by the format, wherein the sink-side control processor samples the command data to form the electrical signal. In another particular case, the system includes a source-side receiver for receiving the electrical signal, and a source-side remote control process for recognizing a remote control signal format associated with the electrical signal, and rebuilding a remote control signal pursuant to the format. In another particular case, the system includes a source-side receiver for receiving the electrical signal, and a source-side remote control process for rebuilding a remote control signal pursuant to a known remote control signal format, and providing the remote control signal to control circuitry of the source device. In another particular case, the system includes a source-side receiver for receiving the electrical signal, and a source-side remote control process for rebuilding a remote control signal pursuant to a known remote control signal format, converting the remote control signal to a modulated IR signal, and providing the IR signal to control circuitry of the source device. In one such case, parameters the modulated IR signal are user-programmable. The system functionality can be implemented, for example, in software (e.g., executable instructions such as C or C++ encoded on one or more computer-readable mediums) and/or hardware (e.g., IR detectors and emitters, and embedded processors or gate level logic or ASICs) or other suitable means.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram of a remote controlled multimedia data communication system, configured in accordance with an embodiment of the present invention.

FIG. 2a is a block diagram of an asymmetrical serial multimedia interface (ASMI) for the source device of FIG. 1, configured in accordance with an embodiment of the present invention.

FIG. 2b is a block diagram of an ASMI for the sink device of FIG. 1, configured in accordance with an embodiment of the present invention.

FIG. 3a is a block diagram of a remote controlled multimedia data communication system configured in a point-to-point connection scheme, in accordance with an embodiment of the present invention.

FIG. 3b is a block diagram of a remote controlled multimedia data communication system configured in a daisy-chain connection scheme, in accordance with an embodiment of the present invention.

FIG. 3c is a block diagram of a remote controlled multimedia data communication system configured with a media center, in accordance with an embodiment of the present invention.

FIG. 4a is a block diagram of a multimedia data communication system configured for integrated remote control signaling, in accordance with an embodiment of the present invention.

FIGS. 4b, 4c, and 4d illustrate an integrated remote control signaling scheme configured in accordance with an embodiment of the present invention.

FIG. 5 illustrates how an example IR remote control signal is characterized as an electrical signal, in accordance with an embodiment of the present invention.

### DETAILED DESCRIPTION OF THE INVENTION

A serial transmission protocol and architecture are provided that can be used to forward remote control data between sink (e.g., DTV) and source (e.g., DVD) devices, in addition to other data such as video/audio/control data. The target device need not be in the line of sight of the remote control beam. Daisy-chained devices will pass the remote control signal to the appropriate target device, so that the user can point any remote control at the DTV or other conveniently located device in the system, and still control the actual target device.

General Overview

One embodiment of the present invention is a protocol that enables a very high bandwidth (e.g., 1.5 GBPS or higher) in one direction for payload data such as video/audio. The transmission path in this direction is called a forward channel. The protocol also enables a relatively low speed communication link in the opposite direction for carrying processing control data, as well as remote control data. This path is called a backward channel. The protocol can be configured to support all the available formats, and is very flexible, so that adoption of new formats is facilitated. Control and timing signals can also be carried by the forward channel from the source device to the sink device for correct video/audio signal regeneration.

The protocol is herein referred to as the Asymmetrical Serial Multimedia Interface (ASMI) protocol, since it has a high bandwidth requirement in one direction and a low bandwidth requirement in the other. The protocol can be transmitted, for example, via a digital optical fiber link, digital optical wireless link, or a radio frequency (RF) link. Similarly, a combination of such links can be used, such as a high speed optical wireless link for the forward channel and a relatively slower speed RF link for the backward channel. In another particular embodiment, a single fiber is used to implement both the forward and backward channels.

The protocol can be used in conjunction with a number of system configurations. In one particular embodiment, a multimedia system configured with a daisy-chain topology is enabled. The system is capable of transmitting uncompressed multimedia data, and includes multiple sources and/or sink devices. The multimedia system can be configured with an automatic and dynamic addressing assignment scheme that allows a user to rewire source and/or sink device cables, wherein all addressing for all networked devices automatically updates to maintain reliable communication. Other system configurations, such as point-to-point and media center configurations, can also be implemented with the protocol.

System Architecture

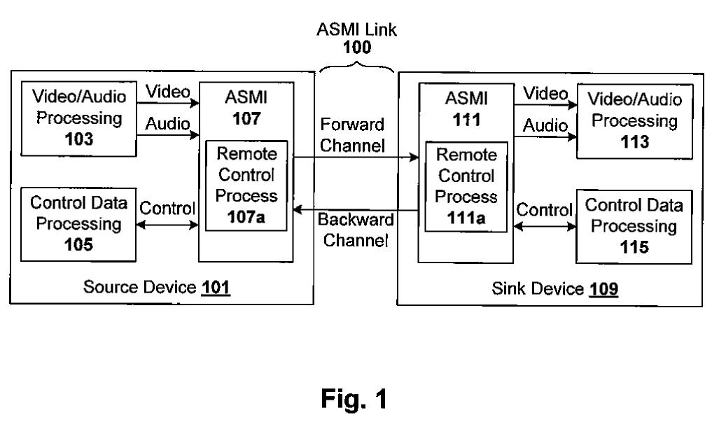

FIG. 1 is a block diagram of a remote controlled multimedia data communication system, configured in accordance with an embodiment of the present invention.

As can be seen, the system includes a source device 101 and a sink device 109 communicatively coupled via an asymmetric serial multimedia interface (ASMI) link 100. The source device 101 can be, for example, a DVD player, satellite/cable receiver box or set-top box, computer, or other suitable multimedia source. The source device 101 generates multimedia data and sends it via the ASMI link 100. The sink device 109 can be, for example, a digital television, monitor, projector or other suitable display device. The sink device 109 receives multimedia data via the ASMI link 100 and displays that data.

In the example embodiment shown in FIG. 1, the source device 101 includes an ASMI section 107 configured with a remote control process 107a, a video/audio processing section 103, and a control data processing section 105. The video/audio processing section 103 can be in the same device as the ASMI section 107 (as shown in FIG. 1). In alternative embodiments, the section 103 can be in a separate device that is operatively connected to the source device 101 via a standard DVI/HDMI cable (or other suitable interconnect). Likewise, the control data processing section 105 can be in the same device as the ASMI section 107 (as shown in FIG. 1). In alternative embodiments, section 105 can be in a separate device that is operatively coupled with the source device 101. In general, any of the functionality described with reference to device 109 can be integrated into one or more modules/components, and the present invention is not intended to be limited to any one configuration.

Likewise, the sink device 109 includes an ASMI section 111 configured with a remote control process 111a, a video/audio processing section 113, and a control data processing section 115. The video/audio processing section 113 can be in the same device as the ASMI section 111 (as shown in FIG. 1). In alternative embodiments, the section 113 can be in a separate device that is operatively connected to the sink device 109 via a standard DVI/HDMI cable (or other suitable interconnect). Likewise, the control data processing section 115 can be in the same device as the ASMI section 111 (as shown in FIG. 1). In alternative embodiments, section 115 can be in a separate device that is operatively coupled with the sink device 109. In general, any of the functionality described with reference to device 109 can be integrated into one or more modules/components.

In operation, the video/audio processing section 103, which can be implemented with conventional technology (e.g., such as that included in a DVD player, satellite/cable receiver box or set-top box, or computer) generates multimedia data (e.g., audio and video), and provides that data to the ASMI section 107. In addition, the control data processing section 105, which can be implemented with conventional technology (e.g., such as that included in a DVD player, satellite/cable receiver box or set-top box, or computer) generates control data, and provides that data to the ASMI section 107. The control data processing section 105 may be further configured to provide additional control functions in accordance with an embodiment of the present invention, as will be apparent in light of this disclosure. These additional control functions (such as those performed by the remote control process 107a) can be implemented within the control data processing section 105, or in a separate control processor module that supplements conventional control functions (as shown in FIG. 1, where the remote control process 107a performs functions that supplement the conventional control functions). The multimedia and control data is multiplexed into a serial stream by the ASMI section 107, and then transmitted to the ASMI section 111 (of the sink device 109) via the forward channel of the ASMI link 100.

The ASMI section 111 demultiplexes the received serial stream back into its multimedia (video and audio) and control data components. The video and audio data are provided to the video/audio processing section 113, which can be implemented with conventional technology (e.g., such as that included in a digital TV, monitor, or projector). The video/audio processing section 113 processes that multimedia data so that it can be displayed/sounded to the user. In addition, the received control data is provided to the control data processing section 115, which can be implemented with conventional technology (e.g., such as that included in a digital television, monitor, projector or other suitable display device). The control data processing section 115 may be further configured in accordance to provide additional control functions in accordance with an embodiment of the present invention, as will be apparent in light of this disclosure. These additional control functions (such as those performed by the remote control process 111a) can be implemented within the control data processing section 115 of the sink device 109, or in a separate control processor module that supplements conventional control functions (as shown in FIG. 1, where the remote control process 111a performs functions that supplement the conventional control functions). The control data supports and otherwise enables, for example, the processing of the multimedia data into the original video/audio, the processing of remote control and other user control functions, and the processing of other data applications, as will be explained in turn.

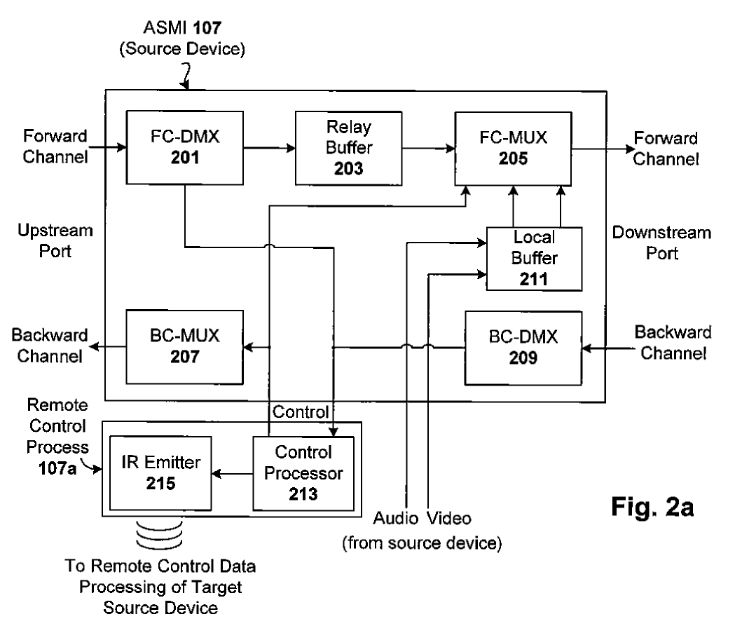

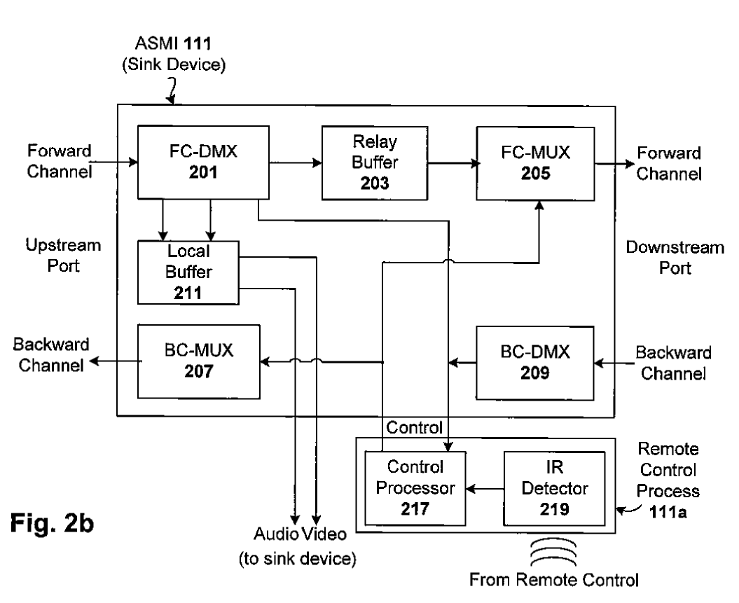

Control data, including remote control data, can also be provided from the sink device 109 to the source device via the backward channel. In particular, control data processing section 115 provides control data to the ASMI section 111, which multiplexes that control data for transmission to the ASMI section 107 (of the source device 101). In addition, the remote control process 111a operates to detect incoming IR remote control data and convert it into electrical signals that can also be multiplexed for transmission to the ASMI section 107. Again, note that remote control process 111a can be integrated into the control data processing 115 (or some other dedicated module) if so desired. In any case, ASMI section 107 then receives and demultiplexes the control data transmitted by the ASMI 111 using the backward channel of the ASMI link 100. That control data is then provided to the control data processing section 105. In addition, the remote control data included in the received control data is regenerated by the remote control process 107a (so that it can be used to control the local source device 101). The ASMI section 107 will be discussed in more detail with reference to FIG. 2a, and the ASMI section 111 will be discussed in more detail with reference to FIG. 2b.

The ASMI link 100 can be implemented using conventional or custom technology (e.g., optical, RF, or combination), and can be wired or wireless or a combination of the two if so desired. In one particular embodiment, the forward and backward channels of the ASMI link 100 are implemented using a pair of optical transceivers communicatively coupled by a single fiber as described in the U.S. patent application Ser. No. 11/173,409. This application Ser. No. 11/173,409, filed on Jun. 30, 2005 and titled, “Bidirectional HDCP Transmission Module Using Single Optical Fiber,” is herein incorporated in its entirety by reference. In such an embodiment, the ASMI section 107 could include or otherwise be coupled with a transceiver module (e.g., VCSEL and photodetector) for implementing the forward channel transmitter and the backward channel receiver. Also, the ASMI section 111 could include or otherwise be coupled with a transceiver module (e.g., LED and PIN detector) for implementing the backward channel transmitter and the forward channel receiver. Numerous wired optical transceiver configurations can be used to effect communication between the devices 101 and 109.

In another particular embodiment, the forward and backward channels of the ASMI link 100 are implemented using an optical wireless communication channel as described in the U.S. patent application Ser. No. 11/142,882. This application Ser. No. 11/142,882, filed on May 31, 2005 and titled, “High Speed Free Space Optical Detection with Grating Assisted Waveguide,” is herein incorporated in its entirety by reference. In such an embodiment, the ASMI section 107 could include or otherwise be coupled with a transceiver module (e.g., transmitter with grating assisted receiver) for implementing the forward channel transmitter and the backward channel receiver. Also, the ASMI section 111 could include or otherwise be coupled with a transceiver module (e.g., transmitter with grating assisted receiver) for implementing the backward channel transmitter and the forward channel receiver. In such a case, the ASMI link 100 is actually a forward communication link and a backward communication link. Numerous wireless optical transceiver configurations can be used to effect communication between the devices 101 and 109.

In another such embodiment, the forward channel can be implemented using any wireless optical link (such as a VCSEL and PIN detector), and the backward channel can be implemented with a relatively slower RF link (e.g., such as an IEEE 802.11 or other such RF wireless communication link).

ASMI for Source Device

FIG. 2a is a block diagram of an ASMI 107 for the source device of FIG. 1, configured in accordance with an embodiment of the present invention. As previously explained, ASMI 107 can exist independently of the source device in other embodiments, if so desired. In addition, note that in this embodiment, the remote control process 107a is implemented externally to the ASMI 107 (as opposed to being integrated as shown in FIG. 1). Numerous such configurations and variations will be apparent in light of this disclosure.

This example ASMI 107 has a downstream port and an optional upstream port. The downstream port includes a high speed forward channel transmission port and a low speed backward channel receiving port. The optional upstream port, which includes a low speed backward channel transmission port and a high speed forward channel receiving port, can receive video/audio signals from an upstream source device in a daisy-chain configuration, as will be discussed in turn.

In operation, the ASMI 107 receives video and audio data from a local video/audio source device (e.g., video/audio processing section 103, such as that included in a DVD player or other such source). The video and audio data is saved into an elastic buffer referred to in FIG. 2a as local buffer 211. The ASMI 107 has a forward channel multiplexer (FC-MUX) 205 that multiplexes the buffered video/audio data for transmission via the downstream high speed forward channel.

If there is an upstream port, the forward channel demultiplexer (FC-DMX) 201 sends received control data, including any remote control data, to a local control processor 213 included in the remote control process 107a. Recall that processor 213 can be included in the ASMI 107 architecture, or otherwise communicatively coupled with the ASMI 107 (as shown in FIG. 2a). Alternatively, processor 213 can be implemented within the control data processing section 105, if so desired. The FC-DMX 201 also temporarily buffers received video/audio data in an elastic buffer referred to in FIG. 2a as relay buffer 203. The FC-MUX 205 also multiplexes the video/audio data from that relay buffer 203 for transmission via the downstream high speed forward channel. The two elastic buffers 203 and 211 (e.g., FIFO buffers) are used to buffer respective stream data while the other stream is being transmitted.

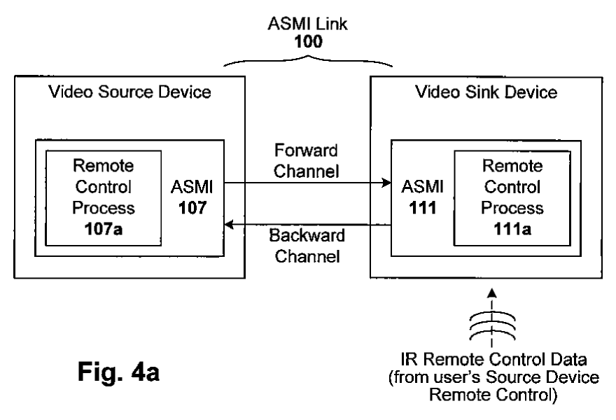

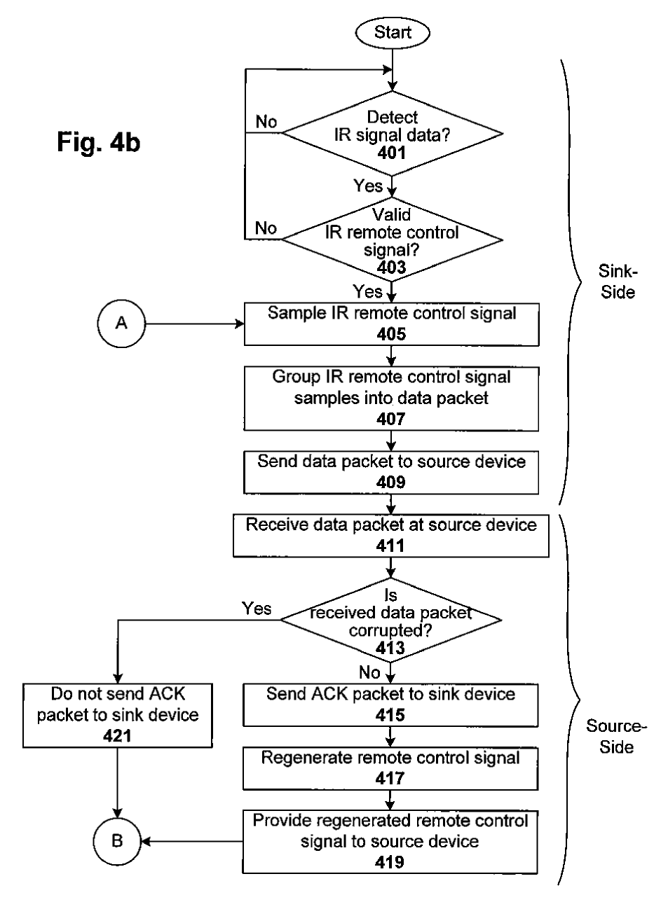

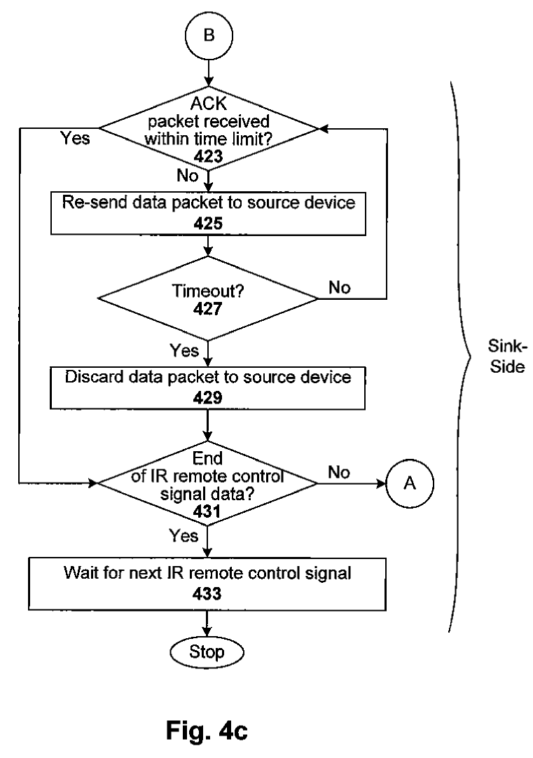

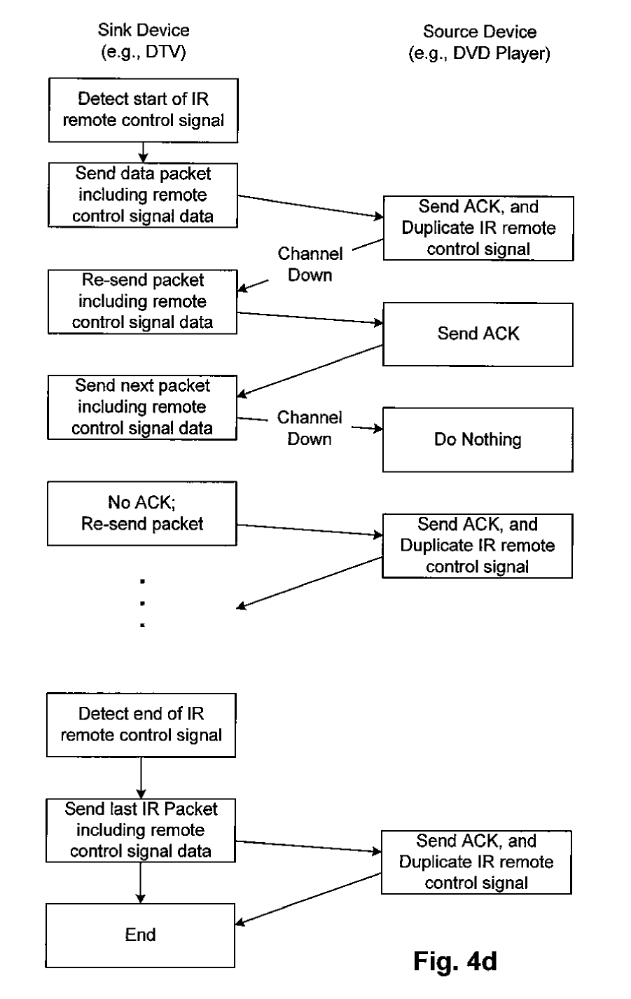

The ASMI 107 also has a backward channel demultiplexer (BC-DMX) 209 that demultiplexes control data (including any remote control data) received via the downstream backward channel, so that control data can then be provided to the local control processor 213. The control data from the upstream high speed forward channel (extracted by the FC-DMX 201) and from the downstream low speed backward channel (extracted by the BC_DMX 209) are sent to the local control processor 213 for processing. Any remote control data destined for the local device is converted back into its IR form by operation of the control processor 213 and IR emitter 215. The control processor 213 also transmits the control data to the downstream device via the FC_MUX 205, and to the upstream device (if there is one) via a backward channel multiplexer (BC-MUX) 207, which multiplexes the control data for transmission via the upstream backward channel. The remote control process 107a (including IR emitter 215 and control processor 213) is discussed in more detail with reference to FIGS. 4a-d.

Communication between the local control processor 213 (and/or the control data processing section 105) and the ASMI 107 can be carried out using custom or conventional technology, such as USB, Ethernet, or universal asynchronous receiver transmitter (UART).

ASMI for Sink Device

FIG. 2b is a block diagram of an ASMI 111 for the sink device of FIG. 1, configured in accordance with an embodiment of the present invention. As previously explained, ASMI 111 can exist independently of the sink device in other embodiments, if so desired.

This example ASMI 111 has an upstream port and an optional downstream port. The upstream port includes a high speed forward channel receiving port and a low speed backward channel transmission port. The optional downstream port, which includes a low speed backward channel receiving port and a high speed forward channel transmission port, can provide video/audio signals to a downstream sink device in a daisy-chain configuration, as will be discussed in turn.

In operation, the ASMI 111 receives video, audio, and control data from the high speed forward channel receiving port. The FC-DMX 201 sends received control data to a local control processor 217. Recall that processor 217 can be included in the ASMI 111 architecture, or otherwise communicatively coupled with the ASMI 111 (as shown in FIG. 2b). Alternatively, processor 217 can be implemented within the control data processing section 115, if so desired. The video and audio data is saved into the local buffer 211, in preparation for display (e.g., by operation of video/audio processing section 113, such as that included in a digital TV or other such sink device). If the received video and audio data is not destined for the local display device, the FC-DMX 201 writes that data into the relay buffer 203. The FC-MUX 205 multiplexes the video/audio data from that relay buffer 203 for transmission via the downstream high speed forward channel. The two elastic buffers 203 and 211 (e.g., FIFO buffers) are used to buffer respective stream data while the other stream is being transmitted.

The control data from the upstream high speed forward channel (extracted by the FC-DMX 201) and from the downstream low speed backward channel (extracted by the BC-DMX 209) are sent to the local control processor 217 for processing. The control processor 217 also transmits the control data to the downstream device (if there is one) via the FC-MUX 205, and to the upstream device via a BC-MUX 207, which multiplexes the control data for transmission via the upstream backward channel. In addition, IR detector 219 is adapted to receive incoming IR remote control signals (provided by a user pointing a remote control at the local sink device), and to convert those IR signals into electrical signals. The control processor 217 then transmits that remote control data (in electrical signal form) to the downstream device (if there is one) via the FC-MUX 205, and to the upstream device via a BC-MUX 207, which multiplexes the control data for transmission via the upstream backward channel. Note that the processing of control information can be implemented the same way as that of source device. The remote control process 111a (including IR detector 219 and control processor 217) is discussed in more detail with reference to FIGS. 4a-d.

Communication between the local control processor 217 (and/or the control data processing section 115) and the ASMI 111 can be carried out using custom or conventional technology, such as USB, Ethernet, or universal asynchronous receiver transmitter (UART).

Each of FC-MUX 205 and BC-MUX 207 can be programmed or otherwise configured to provide simple multiplexing. Likewise, each of FC-DMX 201 and BC-DMX 209 can be programmed or otherwise configured to provide complementary demultiplexing. In one particular embodiment, the multiplexers (FC-MUX 205 and BC-MUX 207) are implemented as a multiplex state machine, and the demultiplexers (FC-DMX 201 and BC-DMX 209) are implemented as a demultiplex state machine. Each of these MUX/DMX state machines will be discussed in turn. Other techniques for serializing data for transmission, and then deserializing that data for receiver processing can be used here, as will be apparent in light of this disclosure.

Automatic/Dynamic Addressing Assignment

As previously discussed, the multimedia system can be configured with an automatic and dynamic addressing assignment scheme that allows a user to rewire source and/or sink device cables, wherein all addressing for all networked devices automatically updates to maintain reliable communication. In more detail, each source and sink device is assigned with an address. This will allow control information (including remote control data) to be passed among all source devices and sink devices.

The address assignment mechanism in accordance with one embodiment of the present invention is designed to satisfy the following requirements: (1) the assignment is fully automatic, so no switch and other user interface is needed; (2) the assignment is dynamic, such that the address is updated to reflect any network cabling change by the user; and (3) the address and its assignment scheme are transparent to the user. The address is based on the position and ordering of each device in the daisy-chain connection.

In one particular embodiment, the address assignment mechanism is implemented using the forward channel data format. In particular, the forward channel format includes a field (e.g., one byte) called upstream device address. In one such case, the address has the following 8 bit format:

| Bit 7 | Bit 6 | Bit 5:0 |
|---|---|---|
| Source Bit | Sink Bit | Position |

| | |
|---|---|
| Source Bit: | 1: The device has video/audio source |
| | 0: The device does not have video/audio source |
| Sink Bit: | 1: The device can display video/audio |
| | 0: The device can not display video/audio |
| Position: | This six bit address is derived from the device |
| | position in the daisy chain. |
| | If there is no upstream port detected, the address shall be |
| | assigned as one. For any one downstream device in the |
| | chain, if the upstream device has an position portion of the |
| | address of i, then that one position portion of the |
| | downstream device address shall be assigned as i+1. |

This upstream device address field makes it possible for the downstream device to update its address whenever the user changes the cable configuration. For example, if the upstream port address received by a downstream device has changed (e.g., because the user has added a new piece of equipment, such as a second DVD player), then the local address assignment for that downstream device is updated so that its address is one plus the address of the received upstream port address. Detecting a change in upstream port address can be carried out, for example, by the local control processor 213 or 217 (or other local computing function). The control processor 213 or 217 can then compute the new address for the device.

Point-to-Point Configuration

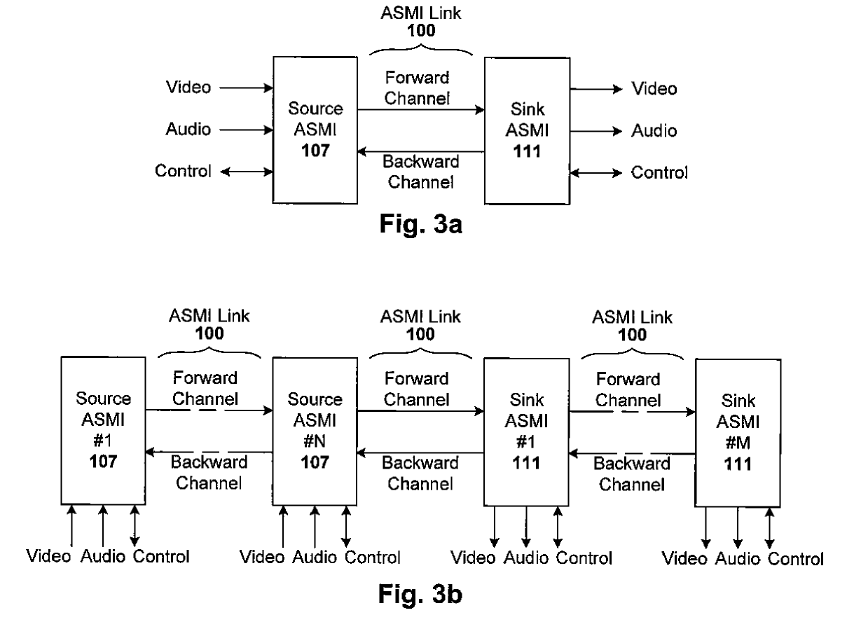

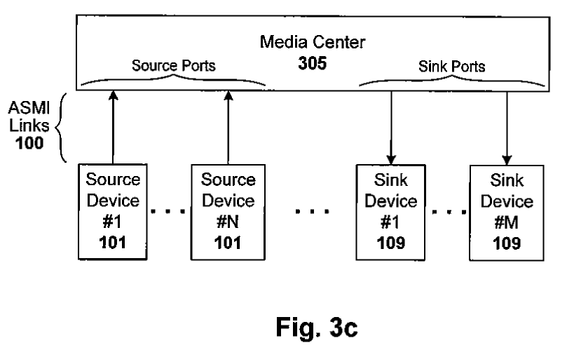

FIG. 3a is a block diagram of a remote controlled multimedia data communication system configured in a point-to-point connection scheme, in accordance with an embodiment of the present invention.

As can be seen, the sink ASMI 111 is connected to the source ASMI 107 via the ASMI link 100. The ASMI 107 receives multimedia data (video/audio) and control data from a source device (e.g., DVD player that includes video/audio processing section 103 and control data processing section 105 with integrated control processor 213), multiplexes that multimedia data and control data into a serial data stream, and transmits that data stream to the sink ASMI 111 via its downstream port and the ASMI link 100. The sink ASMI 111 receives the serial data stream at its upstream port, and demultiplexes it into separate video/audio streams for display/sounding and control data processing by the sink device (e.g., digital TV that includes video/audio processing section 113 and control data processing section 115 with integrated control processor 217). The previous discussions with reference to FIGS. 1, 2a, and 2b are equally applicable here. IR remote control data detected, for example, at the sink ASMI 111 can be converted into an electrical signal, and multiplexed onto the backward channel of the ASMI link 100. The ASMI 107 can then demultiplex that remote control signal data, covert it back into its IR form, and provide it to the local source device (e.g., via the control bus), so as to control that source device in accordance with the remote control commands selected by the user. Note that the source device and ASMI 107 need not be in the line of sight of the user and remote control to be so remotely controlled. A similar scheme for remote controlling the sink device by detecting remote control signals (intended for the sink device) at the source ASMI 107 can also be used, if so desired.

In this example configuration, external video circuitry is used. However, it will be appreciated in light of this disclosure that the ASMI 107 can be integrated into a source device and ASMI 111 can be integrated into a sink device (as shown in FIG. 1, for example).

Daisy-Chain Configuration

FIG. 3b is a block diagram of a remote controlled multimedia data communication system configured in a daisy-chain connection scheme, in accordance with an embodiment of the present invention. This system configuration allows a user to connect several source devices and/or sink devices to form one network. In this particular embodiment, there are N source ASMIs 107 (for N corresponding source devices) and M sink ASMIs 111 (for M corresponding sink devices), where N is not necessarily equal to M, but can be. Under proper control, each of the M sink devices can display/sound video and/or audio data from each of the N source devices. The source ASMIs 107 and/or sink ASMIs 111 are able to pass high speed multimedia data from the upstream device to the downstream device.

As can be seen, each ASMI 107 and 111 in the daisy-chain receives control data from at least one of two sources: from the upstream device via its high speed forward channel receive port, and from the downstream device via its low speed backward channel receive port. The source ASMI #1 does not have an upstream device, and the sink ASMI #M does not have a downstream device. All the control data received at anyone ASMI is sent to the local processor (e.g., control processor 213/217) for processing, and is not relayed to the downstream device directly. If the control data traffic is not targeted to the local device, the local control processor 213/217 will transmit that traffic to other devices via either the backward channel or the control data field in the forward channel data stream, which will be discussed in turn.

In addition, each ASMI 107 and 111 transmits control data to at least one of two places: to the downstream device via its high speed forward channel transmit port, and to the upstream device via its low speed backward channel transmit port. The addressing and processing of the control data can be carried out, for instance, by the local control processor 213/217 and its associated protocols (which may be proprietary or conventional). The ASMI mechanism described in this example system design passes the control data to and from the local processor, and transmits it via the high speed forward channel and low speed backward channel.

In one embodiment, IR remote control data captured at one of the sink devices and converted into electrical signal data is communicated to one of the source devices using the backward channel of the ASMI link 100. In a similar fashion, remote control data captured at one of the source devices can be communicated to one of the sink devices using the forward channel of the ASMI link 100 (although this would not be typical, given user propensity to aim the remote control at a sink device such as a DTV, as opposed to a source device, particularly if that source device is out of the user's forward field of view). In any case, the IR remote signal can then be regenerated and provided to control the target device accordingly.

In a multi-source, multi-sink configuration, there is typically more than one multimedia stream. In order to support this operation, a stream number is used. In more detail, and in accordance with one particular embodiment, each multimedia data stream in the forward channel of the ASMI link 100 has a stream number field. The local control processor 213 of each source device programs or otherwise assigns the stream number. The ASMI 107 of the source device transmits its local multimedia data with this assigned stream number in its header, as will be explained in turn. Similarly, the local control processor 217 of each sink device also programs a stream number. Processor 217 sends any received multimedia data stream including a stream number that matches this local stream number to the local device for display/sounding by operation of the ASMI 111. If the stream number does not match, then processor 217 relays the data stream to the downstream device.

The stream number mechanism facilitates user interface for a stream selection process. In particular, and in accordance with an embodiment of the present invention, each source ASMI 107 transmits with its own address as the stream number. In other words, ASMI #1 will transmit multimedia stream number one, and ASMI #2 will transmit multimedia stream number two, and so on. This can be a default stream number assignment scheme if so desired. Each sink ASMI 111 (e.g., in conjunction with its local control processor 217) will detect the total number of active streams and display them to the user (e.g., via a pull down list or other suitable user interface mechanism). The user can then select the desired video stream by selecting one stream from the displayed list. The user selected stream number can be programmed into one or more ASMIs 111, so that each programmed ASMI 111 will know to deliver stream data having that stream number to the local video/audio circuitry. Any number of known user interface techniques and menu schemes can be used to allow the user to access stream information available from the local control processor 217 of the sink device.

In one particular embodiment, for a source ASMI 107, the local data is first stored in the local buffer 211. If there is an upstream port, the data received from that port is first saved in the relay buffer 203. The merge of the local multimedia data and the data from the upstream device can be implemented, for example, with a simple multiplexing (e.g., FC-MUX 205 and BC-MUX 207), as previously explained with reference to FIGS. 2a and 2b. If the relay buffer 203 is not empty, the FC-MUX 205 will first transmit a whole packet from the relay buffer 203. If the relay buffer 203 is empty, the FC-MUX 205 will transmit a data packet from the local buffer 211. The upstream sink device receives transmitted data via its corresponding ASMI 111. The stream number field in the packet is checked (e.g., by operation of the local control processor 217). If the stream number matches its local number, the FC-DMX 201 of the ASMI 111 then writes the data to the local buffer 211 so that the data can then be displayed/sounded using the local sink device. Otherwise (stream number does not match local number), the FC-DMX 201 writes the data into its relay buffer 203 and relays that data to its downstream port in the same way as the ASMI 107 does (by way of FC-MUX 205).

Just as with the example configuration shown in FIG. 3a, this example daisy chain configuration employs external video circuitry. However, it will be appreciated in light of this disclosure that each of the ASMIs 107 can be integrated into a corresponding source device and each ASMI 111 can be integrated into a corresponding sink device. In general, any combination of source and sink circuitry can be used, whether external to or integrated with ASMI 107 or 111 circuitry. Likewise, any type of multi-component communication system that can be remote controlled by a user can benefit from the techniques described herein, and the present invention is not intended to be limited to multimedia systems.

The transmitted multimedia data (e.g., uncompressed video/audio or any other data communicated by a remote controlled multi-component system) will be associated with a bit rate (e.g., constant bit rate associated with uncompressed multimedia, or variable bit rate data). In any such cases, assume the available bandwidth for the ASMI link 100 and architecture is greater than or equal to the desired highest multimedia data rate to which the system will employ.

Media Center Configuration

FIG. 3c is a block diagram of a remote controlled multimedia data communication system configured with a media center, in accordance with an embodiment of the present invention.

In this configuration, a media center 305 is provided that has one or more source ports and one or more sink ports, each configured with an ASMI as discussed with reference to FIGS. 2a and 2b, respectively. A control processor 203 can be used as the local processor in the media center 305. Each port (or a sub-set of available ports) interfaces with a source device 101 (ASMI 107) or sink device 109 (ASMI 111) in the same way as that in point-to-point topologies (as described with reference to FIG. 3a). There are N source devices 101 and M sink devices 109. Once again, note that M can be equal to N, but need not be.

The source ports of the media center 305 receive multimedia data from a corresponding source device 101 via a forward channel of an ASMI link 100. The ASMI 111 for that port of the media center 310 effectively operates as a forwarding state machine, by routing the received data to the proper sink port. Likewise, the sink ports of the media center 305 receive control data from a corresponding sink device 109 via a backward channel of an ASMI link 100. As will be appreciated in light of this disclosure, the control data may include a representation of IR remote control data captured at the sink device 109. The ASMI 107 for that port of the media center 310 effectively operates as a forwarding state machine, by routing the received control data to the proper source port. In one particular embodiment, each ASMI 111 and ASMI 107 operates under the control of one or more control processors (e.g., processors 213 and 217, generally referred to a “control processor” for this example embodiment) of the media center 305. As discussed herein, the control processor can evaluate address information and/or stream information included in received data packets to effect proper routing of data to its intended destination.

Data Format

In one example embodiment, the multimedia and control data in the ASMI link 100 is transmitted in packets. Each packet covers a fixed number of video pixel clocks. The packet rate on the serial interface is: Pixel clock rate/Packet size (in pixels). Based on this fixed packet size scheme, the sink-side can readily regenerate all the multimedia data and control signals.

Serial Clock Interface

The clock rate for the high speed forward channel of the ASMI link 100 is normally independent of the video clock rate. There may be more than one video/audio source, each with different clocks. Even for one video stream, the video clock can still be different for different video modes (e.g., 480p, 720p, 1080i, etc). In one particular embodiment, the high speed forward channel of the ASMI link 100 runs at a constant clock. The source device (or first source device in the daisy-chain configuration) generates this clock. All downstream devices recover this clock and use it for ASMI operation, including traffic receiving and relaying. In one embodiment, the control processor 217 (or a dedicated module included in ASMI circuit 111) is programmed or otherwise configured to implement known clock recovery techniques.

Multiple Streams

As previously discussed, a multimedia system can be designed to support multiple video/audio streams, in accordance with an embodiment of the present invention. This is useful, for example, for multi-source and/or multi-sink configurations, and for picture in picture applications. In one particular embodiment, there is an 8 bit stream number in the header of each multimedia (e.g., video/audio) data packet to indicate to which multimedia stream this packet belongs. Based on a user's stream selection, the control processor 217 programs a target stream number in the ASMI 111 of each sink device. In addition, each ASMI 107 will transmit all multimedia data from its source device with its corresponding stream number. The downstream sink device will compare the received stream number with its programmed stream number. If the two match, the stream is delivered to the local video circuit (e.g., video/audio processing section 113, such as that in a digital TV) for display/sounding. Otherwise, the packet is relayed to the next down stream port for like processing, until it is received at its intended destination.

Time Stamp Scheme

Videos are displayed in pixels, lines, and frames. Uncompressed video/audio data must be exactly synchronized with timing control signals like HSYNC (Horizontal Synchronization) and VSYNC (Vertical synchronization). In an HDMI/DVI system, there are also CTL control signals to synchronize HDCP and digital audio application. These timing control signals change their state at a specific pixel clock. The status of the signals and the time they are changing are carried over the high speed ASMI link 100 for the sink device to recreate the original video/audio.

In one particular embodiment of the present invention, each of the source devices includes or is otherwise operatively coupled to a circuit configured to record all the control signal changes (e.g., such as a dedicated circuit, control processor 213, or a microcontroller with I/O ports for receiving control signals and port routines to log signal changes). After each signal change, the new control signal values and the relative time at which the change takes place are recorded. These recorded timing data are generally referred to as time stamps. In one such case, all the time stamps are relative to the first pixel time of the packet (or some other consistent time stamp point). In addition, all the time stamps and timing control signal values are transmitted to the sink device together with the multimedia data.

At the sink-side, the video regeneration circuit (e.g., video/audio processing section 113, such as that in a digital TV) starts pixel counting from the first pixel for each packet data. When the count reaches each time stamp, the control signals are generated according to the value in the packet. In this way, all the control timing signals are regenerated at exactly the same time as they are recorded at the source-side. Note that the number of time stamps per packet time is not constant. Thus, a counter can be used to count the number of time stamps for each packet. In one such embodiment, this counter is transmitted from the source device ASMI 107 to the sink device ASMI 111, together with all the time stamps.

Blank Suppression Scheme

Typical video data includes active video pixels and about 15%-20% blank pixels. These blank pixels do not carry useful information and consume valuable bandwidth if being carried over a constrained link. As described in U.S. patent application Ser. No. 10/864,755, these blank pixels can be suppressed to save serial link bandwidth. In such an embodiment, the ASMI link will transmit active pixel data only. application Ser. No. 10/864,755, filed on Jun. 8, 2004, and titled “Scheme For Transmitting Video and Audio Data of Variable Formats Over a Serial Link of a Fixed Data Rate,” is herein incorporated in its entirety by reference. In one such embodiment, the user can select to enable/disable blank pixel suppression for their particular multimedia communication system.

Forward Channel Data Format

In one embodiment of the present invention, the forward channel data transmitted on the ASMI link 100 is in the form of packets. One packet carries the active video data for the pre-specified number of video clocks. All fields in this example format are in the byte boundary, except the number of audio words header field and the number of audio channels header field, which can be combined into one byte. This facilitates transmitting the data using a standard serialize/deserialize (SerDes) interface and with a standard 8B/10B encoding scheme.

Each forward channel packet has the following format shown in Table 1, in accordance with one particular embodiment:

TABLE 1

| Field | | Number of Bytes |
|---|---|---|
| Headers | Packet Sequence Number | 1 |
| | Video Stream Number | 1 |
| | Number of Audio Words | ½ |
| | Number of Audio channels | ½ |
| | Video Mode | 1 |
| | Number of Active Video Words | 2 |
| | Number of Video Time Stamps | 1 |
| Control | Upstream Device Address | 1 |
| Words | Control Data | 12 |
| Time Stamps | Time Stamps 1 | 3 |
| | Time Stamps 2 | 3 |
| | Time Stamps n | 3 |
| Audio | Up to Four Channel of Audio Data | Variable |
| Video | Active Video Pixel Data | Variable |

The Packet Sequence Number is used for each device to synchronize with each other. It is incremented by one for each packet transmitted at the source. The number is wrapped back to zero when its maximum value is reached. Each downstream device should see a constantly incrementing number for this field if no packet is lost.

Video Stream Number is used for multi-video stream modes. It indicates to which video stream this packet belongs. Each device is programmed with a local steam number by the local control processor 213/217. The default value of this field is the same as the device address. The source device will use this number to transmit its multimedia data streams. The sink device will compare this field with its locally programmed number.

Number of Audio Words indicates the number of audio words transmitted in this packet. Since the audio circuit and video circuit may not share the same clock, the number of audio words generated during one video packet time is not constant. Source devices set this field and the sink devices use this field to demultiplex the correct number of audio words from the stream.

Number of Audio Channels indicates the number of audio channels transmitted in this packet. Data for each audio channel is transmitted sequentially until all the channels are transmitted.

Video Mode indicates the video mode being transmitted by this packet (e.g., 480p, 720p, 1080i, etc).

Number of Active Video Words indicates the number of active video words transmitted by this packet. Since only the active video data is being transmitted (in one particular embodiment), the number of active video data determines the packet size. The difference between Number of Video Words and Number of Active Video Words is the number of video clocks in the blank period.

As described previously, the Upstream Device Address field specifies the address of the upstream device and can be used for automatic address learning and multi video stream application.

Control Word is used to carry general purpose control data, including remote control data. Other control data can be, for example, HDCP related control information, home entertainment control information, Internet related information, and other such control information, as needed. Control words are used to exchange data among the control processors 213/217 in each device. In the forward channel of the ASMI link 100, and according to one particular embodiment of the present invention, a control word has the following format shown in Table 2:

TABLE 2

| Bytes | Content |
|---|---|
| 1 | Source Address |
| 2 | Destination Address |
| 3 | Header |
| 4 | Data Byte 1 (payload) |
| 5 | Data Byte 2 (payload) |
| 6 | Data Byte 3 (payload) |
| 7 | Data Byte 4 (payload) |
| 8 | Data Byte 5 (payload) |
| 9 | Data Byte 6 (payload) |
| 10 | Data Byte 7 (payload) |
| 11 | Data Byte 8 (payload) |
| 12 | CRC |

In one particular embodiment, the control processor 213/217 in each source or sink device performs segmentation and re-assembly functions and transmits data by this eight byte payload field. Either in point-to-point or daisy-chain configuration, the whole received control word is passed to the local control processor 213/217 for interrogation. In the same way, the local control processor 213/217 will generate all the control data traffic for the downstream device.

Audio Word has variable length and carries all the audio data. The length of this field is determined by the number of audio channels and the number of audio words fields. At the beginning of the audio word field, a four bit audio mode is first transmitted.

1: 12S

2: SPDIF

Others: Reserved for Future Expansion

The audio clock count field is used for the sink device's audio PLL to regenerate the original audio clock. This field indicates the number of audio clocks counted during the past packet time. In one particular embodiment of the present invention, the audio words are transmitted in the following order shown in Table 3:

TABLE 3

Audio Mode: 4 bit
Audio Clock Count: 12 bit
Audio Word 1: Channel 1
Audio Word 1: Channel 2
Audio Word 1: Channel 3
Audio Word 1: Channel n
Audio Word 2: Channel 1
Audio Word 2: Channel 2
Audio Word 2: Channel 3
Audio Word 2: Channel n
Audio Word m: Channel 1
Audio Word m: Channel 2
Audio Word m: Channel 3
Audio Word m: Channel n

Video Word has variable length and carries all the video data. The length of this field is determined by the number of active video words. Although the number of video pixel clocks during one packet time is constant, the number of active pixels is variable since there is blank pixel time. Note that the ASMI does not interpret or alter the video data content. It simply passes the data in the same order from source to sink devices. The video word field sequentially carries all the video data from the source device to the sink device. For a typical 24 bit video (standard HDMI/DVI interface and most video devices today), every pixel of video is carried by three bytes of high speed serial data.

For higher resolution (e.g., 30 bit) video, the number of bits for each video pixel may not be multiples of bytes. The video word field still sequentially carries all the video data from the source device to the sink device. The following scheme can be used, in accordance with one embodiment of the present invention for 30 bit video transmission: Each pixel of video shall be carried by four bytes of high speed serial data. Although this transmission scheme can cause the waste of 2/32=6% of bandwidth, it simplifies the data alignment and circuit design. Thus, a trade-off between wasted bandwidth and simplified alignment/circuit design can be considered when implementing a given application.

Backward Channel Data Format

The data format for the backward channel will now be described, in accordance with one embodiment of the present invention. In one particular embodiment of the present invention, the backward channel data has a similar format as the control data in the forward channel.

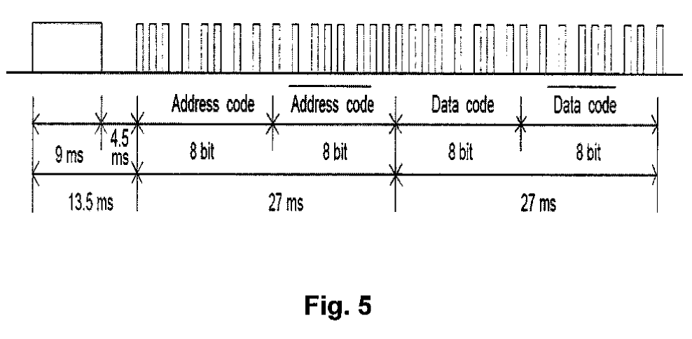

In one such case, the backward channel packet has a Preamble field and a Start Frame Delimiter (SFD), as is typical in communication networks. A Packet Size field can also be provided, so as to enable a variable packet size, if so desired. In one particular implementation, the source address and destination address have the same meaning as that of the forward channel control data. The control data can also have variable size (up to 256 bytes in this example). As will be apparent in light of this disclosure, the control data can include a representation of IR remote control data captured at a device included in the system. The control data may also specify the particular IR code used (e.g., NEC code, or other such IR remote control codes) to generate the IR remote control data, thereby enabling the receiving device to re-generate the remote control data code from remote control command data only (e.g., change channel command or volume command). In more detail, start and stop sequences associated with the IR code, as well as any complement data, need not be transmitted (via the ASMI link) with the remote control command data. This is because if the receiving device already knows the IR code used, then start and stop sequences and any complement data can be generated at the receiving device independently of the actual remote control command data. This will be discussed in further detail with reference to FIG. 5. In one particular embodiment, a CRC field having a two byte length is also provided. An example backward channel packet is shown in Table 4:

TABLE 4

| Field | | Number of Bytes |
|---|---|---|
| Preamble | | 2 |
| SFD | | 1 |
| Header | Packet Size | 1 |
| | Packet Type | 1 |
| | Source Address | 1 |
| | Destination Address | 1 |

| | |
|---|---|
| Control Data | Up to 256 |
| CRC | 2 |

In one particular embodiment of the present invention, each sink ASMI has a state machine for demultiplexing (e.g., FC-DMX 201 and BC-DMX 209) incoming data, and a state machine for multiplexing (e.g., FC-MUX 205 and BC-MUX 207) outgoing data. In one such embodiment, the demultiplexing state machine receives data from the upstream ASMI and separates the data into three data streams (video, audio, and control). The multimedia data (video and audio) with a video stream number that matches or otherwise corresponds to the sink device is stored in the local buffer 211 for display/sounding. The multimedia data with a non-matching video stream number is stored in relay buffer 203 for relaying to the downstream port. The control data is transferred to the local control processor 213/217, as previously explained. All these separations can be performed by the demultiplexing state machine based on the predefined packet format discussed herein. The multiplexing state machine of each sink ASMI receives remote control data (e.g., captured by IR detector 219 and processed by control processor 217) from the user's remote control, and multiplexes that control data onto the backward channel and/or forward channel for transmission via the ASMI link 100.

Each source ASMI has a state machine for demultiplexing (e.g., FC-DMX 201 and BC-DMX 209) incoming control data (including remote control data), and a state machine for multiplexing (e.g., FC-MUX 205 and BC-MUX 207) outgoing data. In one such embodiment, the demultiplexing state machine receives remote control data from the downstream ASMI, and regenerates the IR remote control signal (e.g., with processor 213 and IR emitter 215). The source multiplexing state machine receives multimedia data (video and audio) from the local video/audio circuit (e.g., DVD player etc.) via the local buffer 211, and takes relayed upstream multimedia data from the relay buffer 203 if there is any, as well as the control data from the local control processor 213. The multiplexing state machine then multiplexes all the data and transmits that data to the downstream ASMI via the ASMI link 100.

Multiplexing State Machine

The following pseudo code illustrates the multiplexing state machine, in accordance with one embodiment of the present invention:

```
State Idle:
  If (Relay_Buffer Non empty)
    Set Flag: Relay_up_stream_port
    Transmit Sequence Number
    Increment Sequence Number
    Go to State Transmit_Header
  Else if (Local Video data Ready)
    Set Flag: Transmit_Local_Video
    Transmit Sequence Number
    Increment Sequence Number
    Go to State Transmit_Header
  Else
    Go to State Idle
State Transmit_Header:
  If (Relay_up_stream_port)
    Relay header from Relay_Buffer to downstream port
    Go to State Transmit_Control_Data
  Else if (Transmit_Local_Video)
    Transmit number of audio word and number of audio channel
    Transmit video stream number
    Transmit video mode
    Transmit number of active video word
    Transmit number of video time stamps
    Go to State Transmit_Control_Data
State Transmit_Control_Data:
  Transmit upstream device address
  Transmit General Purpose Control Data from local processor
  Go to State Transmit_Time_Stamps
State Transmit_Time_Stamps:
  If (Relay_up_stream_port)
    Relay all video time stamps from the Relay_Buffer
    Go to State Transmit_Audio_Data
  Else if (Transmit_Local_Video)
    Transmit all video time stamps (specified by number of time stamps)
    from
      local video device
    Go to State Transmit_Audio_Data
State Transmit_Audio_Data:
  If (Relay_up_stream_port)
    Relay all Audio Data from the Relay_Buffer
    Go to State Transmit_Video_Data
  Else if (Transmit_Local_Video)
    Transmit audio data (specified by number of audio word) from local
      device
    Go to State Transmit_Video_Data
State Transmit_Video_Data:
  If (Relay_up_stream_port)
    Relay all Video Data from the upstream port
    Go to State Idle
  Else if (Transmit_Local_Video)
    Transmit all video data (specified by number of active Video Data)
    from
      local video device
    Go to State Idle
```

Demultiplexing State Machine

The following pseudo code illustrates the demultiplexing state machine, in accordance with one embodiment of the present invention:

```
State Idle:
  If (Upstream_ASMI_Packet_Detected)
    Go to State Receive_Sequence_Number
  Else
    Go to State Idle
State Receive_Sequence Number
    Record packet sequence number
    Go to State Receive_Stream_Number
State Receiver_Stream_Number:
  If (Stream_number matches local sink device address)
    Set Local stream flag
    Go to State Receive_Header
  Else
    Clear Local stream flag
    Go to State Receive_Header
State Receive_Header:
  If (Local Stream)
    Store header to local_buffer
    Go to State Receive_control_word
  Else
    Store header to relay_buffer
    Go to State Receive_control_word
State Receive_control_word:
  Transfer general purpose control word to local processor
  Go to State Receiver_Audio_Data
State Receive_Audio_Data:
  If (Local Stream)
    Transmit audio data (specified by number of audio word) to local
    device
    Go to State Receive_Video_Data
  Else if (Transmit_Local_Video)
    Relay all audio Data (specified by number of audio word) to relay_{—}
    buffer
    Go to State Receive_Video_Data
State Receive_Video_Data:
  If (Local Stream)
    Transmit video (specified by number of active Video Data) to local_{—}
    buffer
    and local video device
    Go to State Idle
  Else if (Transmit_Local_Video)
    Relay all Video Data from the upstream port to the relay_buffer
    Go to State Idle
```

HDCP over ASMI

HDCP (High Definition Content Protection) is a protocol developed for the HDMI and DVI interface to carry protected video/audio signals. One embodiment of the present invention can be used to implement the HDCP protocol over the ASMI link 100. The employed communication schemes are based on HDCP specification. All the key vectors and key exchange schemes are the same as HDCP. The generation and application of the encryption polynomials are the same as that in the standard HDCP protocol.

Data transmitted over the forward channel serial link are encrypted. In the source device, the data is encrypted at the parallel bus before the SerDes. On the sink-side, the data is decrypted at the parallel bus of the SerDes output. In a typical HDMI or DVI based HDCP system, the source device periodically (about every two seconds) reads link verification value Ri′ from the sink device. The link verification fails if the Ri′ value is wrong.

If the data is carried over an optical wireless link for the forward channel, the backward channel can be implemented with an RF wireless link (e.g., 802.11 or other suitable RF wireless link technology). A typical wireless link has more noise and more transmission errors. However, there are techniques that can be used to improve the reliability of the HDCP link verification in the noise environment. One technique is more retransmission. In particular, the link verification value Ri′ can be sent from sink to source every millisecond (or so), continuously. A few corrupted values will be detected and not cause any problem. Another technique is where the source-side can compare the received value with its newly generated value and previous value. Either match indicates a valid HDCP verification. With this technique, any delay of the new Ri′ caused by network latency or re-try latency will not cause HDCP verification failure.

For the sink-side to decrypt the data correctly, the sink and source device must be in exact synchronization for all packets and all data words. Packet data format for the ASMI as described herein provides an easy way for this synchronization. In particular, each packet header contains a packet sequence number. Sink and source devices can use this sequence number to get synchronized with each other. All the key exchange, key update, polynomial generation, data encryption and decryption are all synchronized with this sequence number.

Remote Control Signal Processing

FIG. 4a is a block diagram of a multimedia data communication system configured for integrated remote control signaling, in accordance with an embodiment of the present invention.

As can be seen, the link between the source device and sink device is implemented with an ASMI scheme as described herein. There is no physical copper wire between the two ASMI 107 and 111. In this embodiment, the ASMI device 107 and/or ASMI device 111 (along with their respective remote control processes 107a and 111a) are integrated into their corresponding video source and sink devices. The ASMI 107 and ASMI 111 are communicatively coupled by ASMI link 100 (e.g., a high speed forward channel and lower speed backward channel). In other embodiments, the ASMI 107 can exist independently of (and be connected to) the video source device, for example, via a standard HDMI/DVI interface. Likewise, the ASMI 111 device can exist independently of (and be connected to) the video sink device.

The forward channel of this example embodiment provides high bandwidth for video, audio and/or other types of user data to the video sink-side (e.g., DTV), while the backward channel with relatively low data bandwidth is utilized to carry user data for link integrity checking and other purposes (including transmission of remote control data) to the video source-side (e.g., DVD player). IR control signal data from the user's remote control is captured by the remote control process 111a and converted into electrical signals that are multiplexed on the backward channel by operation of ASMI 111. Those remote control signals are communicated over the ASMI link 100 and received at the video source device ASMI 107, which demultiplexes the remote control signals and provides them to the remote control process 107a. The remote control process 107a can then convert those control signals into a form usable by the video source device to effect the requested control on the source device. For instance, the remote control process 107a can convert the control signals back into IR form to illuminate an IR sensor of the video source device control circuit. Other embodiments may provide the control signals in another form (e.g., electrical signal) suitable to activate the video source device control circuit.

In more detail, and in accordance with one embodiment of the present invention, the output of IR detector 219 of the remote control process 111a is high when there is no IR control data present. When the IR detector 219 detects IR control data (e.g., after a user engages the remote control of the video source device to advance through chapters of a DVD or other such source device control), the IR detector 219 outputs a stream sequence of high and low pulses. The stream starts with a period of low signal, and ends of a period of high signal. This output could be represented as the digital “0” and “1” stream levels, where “0” is for low part of the IR signal, and “1” for the high part of IR signal.

In one particular configuration, the control processor 217 of the remote control process 111a is programmed or otherwise configured with a threshold of IR low period (e.g., low lasting greater than 2 milliseconds) to be recognized as the start of a valid IR control data signal. In this way, the sparse IR low signals from fluorescent lamps and other IR “noise” sources can be effectively filtered out or ignored. When the remote control process 111a detects a valid start of IR control data, it commences to sample the incoming IR data stream with a sample period. In one such embodiment, two factors are considered when this sample period is selected: signal distortion and the amount of data stream to represent the detected IR control data signal. In general, the shorter the sample period, the lower the IR signal distortion level when it is restored at the video source-side. However, the shorter the sample period, the more data that is needed to characterize the signal.

In one particular case, eight samples are grouped as a byte. In such an embodiment, the ASMI 111 is configured to place a fixed length of bytes (e.g., 128 bytes) into a FIFO buffer (included in the control processor 217 or in a dedicated buffer). The FIFO buffer contents are processed into a packet by operation of the control processor 217. The packet is then multiplexed onto the backward channel by operation of BC-MUX 207 for transmission over the ASMI link 100 to the ASMI 107 of the video source device.

After the ASMI 107 of the video source-side receives the IR control data packet, it sends an acknowledgement (ACK) packet to the ASMI 111 by the forward channel to inform the ASMI 111 of the IR control data packet reception. If the received IR control data packet is corrupted on the back channel transmission, the ASMI 107 will not send the ACK packet to the ASMI 111 of the video sink-side. If the ASMI 111 does not receive the ACK packet in a given period of time (e.g., 1 millisecond), the ASMI 111 will resend the IR control data packet, until it receives an ACK packet or until a timeout occurs. The timeout mechanism is used to prevent resending of IR data packet in perpetuity (e.g., in the event of a disabled link 100 or other communication failure). After timeout, the ASMI 111 discards the IR control data, and prepares to send a next IR control data packet if any IR packet is pending to be sent. IR data sampling is stopped after the ASMI 111 detects the end of the IR control data signal (e.g., a period of IR high signal). This data packet that includes the “end of IR control data signal” indicator is the last packet for a valid IR control data signal stream.

The remote control process 107a of ASMI 107 can regenerate the received remote control signal data in various ways. In one particular embodiment, the direct output of digital signal is used (i.e., no conversion to IR). Such a direct digital output can readily interface with other digital remote control circuitry included in the video source device. Alternatively, the output of digital remote control data signal can be converted to a modulated IR signal. For instance, the direct digital output can be used to drive an IR LED to emit a corresponding IR signal. This type of IR signal can also be readily received by a video source device, which typically has built-in IR detector circuitry. The modulated frequency and duty cycle of the remote control process 107a is user-programmable, thereby providing a universal solution.

Methodology

FIGS. 4b and 4c illustrate an integrated remote control signaling scheme configured in accordance with an embodiment of the present invention. As can be seen, this example method includes a number of steps carried out at the sink-side and another steps carried out at the source-side. Numerous variations will be apparent, and the present invention is not intended to be limited to any one such configuration. Moreover, the example embodiment is not intended to implicate any rigid ordering of steps or temporal limitations. Rather, the steps can be processed in any logical order an in a synchronous or asynchronous manner. The method can be carried out, for example, by the systems and modules discussed with reference to FIGS. 1, 2a, 2b, 3a, 3b, 3c, 3d, and 4a. The various functionalities can be implemented in software, hardware, or a combination thereof, as will be apparent in light of this disclosure.

The method includes determining 401 if IR signal data has been detected. If not, the method continues to wait for IR signal detection. Once IR data is detected, the method continues with determining 403 if the detected IR signal is a valid IR remote control signal (e.g., based on a pre-defined start signal parameter as previously discussed). If not, then the method continues to wait for a valid IR remote control signal detection. Otherwise, the method continues with sampling 405 the IR remote control signal, and grouping 407 the IR remote control signal samples into a data packet (one or more data packets can be used, depending on the packet format used). The method proceeds with sending 409 the remote control data packet to the source device via a serial communication link. As previously explained, one embodiment implements the communication link with a single fiber having a forward channel and a backward channel. The remote control data packet can be communicated using the backward channel. In other embodiments, the remote control data packet is communicated wirelessly using an optical beam (e.g., IR transceivers configured with grating assisted waveguides). Other embodiments can use an RF link (e.g., 802.11) to transmit the remote control data packet to the source-side.

At the source-side, the method includes receiving 409 the remote control data packet at the source-side, and then determining if the received remote control data packet is corrupted. If not, then the method continues with sending 415 an ACK packet to the sink device, and regenerating 417 the remote control signal. Note that this regeneration may include providing an electrical output signal (which may or may not have the same format as the received signal), or an IR signal generated from the received signal. The method continues with providing 419 the regenerated remote control signal to source device, thereby controlling that device based on the user's remote control action provided at the sink device. If the received packet is corrupted, the method continues with not sending 421 an acknowledgement (ACK) packet to the sink device.

At the sink-side, the method includes determining 423 whether an ACK packet has been received within the pre-set time limit. If not, the method continues with re-sending 425, and determining 427 if a timeout has occurred. In one such embodiment, a timeout can be signaled if the remote control data packet has been re-sent more than three times, although numerous timeout schemes can be used. If a timeout has occurred, then the method continues with discarding 429 the remote control data packet (note that this situation will rarely occur). If no timeout has occurred, then the method continues by repeating steps 423 and 425 until either an ACK packet is timely received or a timeout occurs. In either case, the method includes determining 431 whether an end of remote control data signal has been received. If not, the method may repeat (e.g., steps 405 through 429 as needed, notwithstanding timeouts and other such desired flow control mechanisms). If an end of remote control data signal has been received, then the method includes waiting 433 for the next IR remote control signal by the user.

FIG. 4d shows how the ASMI-enabled source and sink devices handle the case when the forward and/or backward channel is impaired, in accordance with an embodiment of the present invention.

As can be seen in this example exchange, the sink device (e.g., DTV) detects the start of an IR remote control signal and then sends (via the backward channel of the ASMI link) a packet including remote control signal data to the source device (e.g., DVD player). The source device then sends an ACK packet (via the forward channel of the ASMI link), and provides the remote control signal data to the source device control circuitry. However, the forward channel is down, and the ACK packet is therefore not received by the sink device. Thus, after a pre-set period of time, the sink device re-sends (via the backward channel) the packet including remote control signal data to the source device. The source device then sends an ACK packet (via the forward channel), which this time is received by the sink device. Note that the source device recognizes the remote control signal data packet was previously received and processed, and does not duplicate that remote control data a second time (rather, only an ACK is sent). In response to the ACK, the sink device sends the next packet including remote control signal data to the source device. However, the backward channel is now down, and the source device therefore never receives the packet. As a result, the source device does nothing. Thus, after a pre-set period of time, the sink device re-sends (via the backward channel) that next packet to the source device. The source device then sends an ACK packet (via the forward channel), and provides the remote control signal data to the source device control circuitry. This process of sending packets including remote control data and acknowledgment can be repeated any number of time to communicate all remote control data provided by the user. Eventually, the sink device will detect an “end of IR remote control signal” indicator, and send the last packet for the incoming IR input sequence. The source device receives the last packet, provides the remote control signal data included in that last packet to the source device control circuitry, and sends an ACK in response to the sink device, thereby terminating that particular exchange.

Remote Control Signal Format

The scheme described herein to sample an IR remote control signal at one device and send it to another device via an ASMI is a universal and integrated IR repeating solution. As is known, IR remote control signals have different standards among manufactures. For a specific manufacture, the format of IR remote control signals is typically consistent due to the compatibility consideration of the legacy product. In this case, a method can be employed to recognize the IR remote control signal from a number of remote control manufactures, and to abstract that signal to a few bytes of data that describe the IR remote control signal. To send these fewer bytes of data requires lower bandwidth.

FIG. 5 illustrates how an example IR remote control signal (based on NEC framing for a key code press) is characterized as the digital signal data, in accordance with an embodiment of the present invention.

As is known, the start sequence or lead code of the NEC data format is a 9 milliseconds (ms) carrier of 38 KHz square wave, followed by a 4.5 ms idle period. An ideal IR detector would detect this modulated IR signal as 9 ms low and 4.5 ms high. After this lead code sequence, the NEC data format continues with a first byte (8-bits) of address data, the complement of the address byte, a second byte of command data, and the complement of the second byte. The address code identifies the device to be controlled, such as TV and DVD. The data code is the command, such as volume up/down, power on/off, fast forward, rewind, etc.

Generally stated, the ASMI scheme described herein need not be aware of the meaning of this vendor-specific data, but need only recognize the valid address code byte and data code byte, so that duplication may take place (e.g., at target source device). As is further known, the NEC data format uses an equal length carrier active and idle (e.g., time T=0.5625 ms) to represent data 0, and a carrier active with time T followed with 3T of idle to represent the data 1 (e.g., data 0 is 0.5625 ms of 38 Khz square wave, then 0.5625 ms idle, while data 1 is 0.5625 ms of 38 Khz square wave, then 3*0.5625=1.6875 ms idle). Assuming the source device knows that the NEC code is being used, then only the address byte and the command data byte need to be transmitted. This technique can be applied to IR codes of other vendors/manufactures as well, whether standard or proprietary, and the present invention is not intended to be limited to any one particular code or set of codes.

After the source-side receives the address code byte and data code byte, the remote control process 107a can then generate the 13.5 ms lead code, the address code corresponding to the transmitted address code byte, the complement address code, the data code corresponding to the transmitted data code byte, and the complement data code. Thus, transmitting only necessary IR code data effectively provides a compression scheme that uses very low bandwidth of the back channel. For example, note that if the sample period is 10 microseconds (us), then there are more than 6750 bits of data ([13.5+27+27]ms/10 us=6750 bits) needed to wholly represent this example remote control data signal shown in FIG. 5. That is 843.75 bytes of data. In accordance with an embodiment of the present invention, if the two bytes of data (one for address code and one for data command code) characterizing the IR remote control signal are extracted, then only 2 bytes of data need to be transmitted, which is a significant bandwidth savings.

Note that such IR signal data recognition and extraction is not limited to identifying key press codes, but can be used for any signal patterns provided by any remote control. For instance, the techniques described herein can also be used to detect repeat codes. As is known, a repeat code is a signal sent by a remote control when a particular key, such as volume up or down, is held down for a period of time by the user. One example is the NEC IR repeat code, which is 9 ms of carrier active, 2.25 ms of idle, followed by one bit of data 0, and finally an idle time of 108 ms. Any such known signal patterns or framing codes can be recognized (e.g., by the remote control processes 107a and 111a), so as to allow the command data to be efficiently communicated over the ASMI link. The receiving device can then re-build the remote control signal (including the command data and any other sections such as start and stop leaders) pursuant to that signal's particular code/framing structure.

IR signal recognition techniques can, for example, exploit unique characteristics of the transmitted data (with such characteristics being sufficient to distinguish one framing code from another). In one such embodiment, each of the remote control processes 107a and 111a is programmed or otherwise configured to analyze the characteristics of received remote control data and to compare those characteristics to stored characteristics of known IR framing codes (e.g., stored in local memory or otherwise accessible to the recognition process). Once a “match” is found (based on characteristic comparison), then the IR code is recognized and can be processed according to a set of predefined instructions. The predefined instructions may include, for instance, what IR control signal data is to be sent by the sending device (e.g., only send command data), as well as rebuilding instructions (e.g., start and stop code definitions and/or other framing parameter definitions used by the receiving device to rebuild the IR code signal). In such an embodiment, both the sending and receiving devices are capable of recognizing the IR code being used. Alternatively, the recognition can be carried out at the sink device (e.g., by operation of remote control process 111a analyzing parameters of the IR control signal and comparing to parameters of known IR control signal formats), and the identified IR code can then be included in the control packet provided to the source device, thereby enabling the source device to readily identify and reconstruct the code. Alternatively, the IR code being used for a particular system can be “hardcoded” into the sink and source devices (so no analysis and comparison to known codes is necessary). In one such embodiment, the IR code could be user-configurable. For instance, the user could program the system to operate with one of a number of known remote control manufactures (e.g., where user is presented with a pull-down menu of possible manufactures can select the appropriate one). Alternatively, the system can be programmed or otherwise configured to “learn” a particular remote control by asking the user (e.g., via an on-screen graphical user interface) to select various remote control functions while the system “listens” (via an IR detector) to learn the corresponding codes for each function. Once an IR control signal data set is learned, the system can then reduce the data transmitted between sink and source devices to core data (e.g., command data), wherein rebuilding of the IR code at the receiving device can take place as described herein. Alternatively, if the IR code is not known and/or cannot be recognized for whatever reason, then all of the remote control signal data can be transmitted (which will require additional channel bandwidth, but is still an embodiment of the present invention).

Note that the integrated remote control signaling scheme could repeat the IR signal with the same frequency of the IR detector, or a frequency configured by the end user. The output remote control signal of the receiving device could be a stream of digital data that can be provided directly to the control circuitry of the target device, or a modulated signal to drive an IR LED that will illuminate remote control detection circuitry of the target device. The frequency and duty cycle of this modulated signal could be programmed for the maximum sensitivity of the source device IR detector. For instance, consider the case where the center frequency of the remote control device and the IR detector of the source device is 40 KHz, and the center frequency of the IR detector in the sink device is 38 KHz. In such a case, the 38 KHz IR detector of the sink device can still be used to capture the 40 KHz IR remote control signals (with some negligible loss of sensitivity). Once the captured IR signal is processed and transmitted from the sink device to the source device, the remote control signal can be rebuilt with its original 40 KHz IR carrier signal. In this way, maximum sensitivity for the source-side IR detector is provided. On-screen display (OSD) interface of sink device can be programmed to allow the user to program carrier/center frequencies of the source and/or sink devices if so desired.

By utilizing two-way communication as described by one embodiment herein, an IR remote control signal can be securely duplicated on the source-side when the user provides the remote control signal to the sink-side. The integrated solution makes controlling a video source device easy for a user, in that the user can intuitively point the IR remote control at the video sink device (e.g., TV) to control a source device that is not in the consumer's forward field of view. No separate cabling for carrying the remote control signals is needed. Rather, the remote control signaling data is carried, for example, in the same fiber as the payload data (e.g., video and/or audio), or via a wireless transmission (e.g., RF or optical). In either such cases, a forward channel can simultaneously carry payload data from the source device to the sink device.

The foregoing description of the embodiments of the invention has been presented for the purposes of illustration and description. It is not intended to be exhaustive or to limit the invention to the precise form disclosed. Many modifications and variations are possible in light of this disclosure. For example, multimedia typically includes video and audio data. However, embodiments of the present invention can operate with any type of data, such as presentation slides, study materials, graphics (e.g., digital art or slide shows, with or without audio), audio only (e.g., music or audio books), and video (e.g., movies with or without audio), or other types of data that can be presented in a system having one or more sink devices and one or more source devices that operate under remote control. It is intended that the scope of the invention be limited not by this detailed description, but rather by the claims appended hereto.

What is claimed is:

1. A method for communicating remote control information in a system including a source device and a sink device that are communicatively coupled by a serial communication link that includes a forward channel and a backward channel, comprising:
at the sink device, detecting infrared (IR) remote control signal data for the source device;
sampling the IR remote control signal data to form an electrical signal; and
sending the electrical signal to the source device via the backward channel, wherein the forward channel can simultaneously carry payload data from the source device to the sink device;
wherein the backward channel is implemented using a single fiber optic cable or a wireless transmission, and the forward channel is implemented using the same single fiber optic cable as the backward channel or an optical wireless transmission.

2. The method of claim 1, further comprising:
at the sink device, determining if IR data has been detected; and
in response to IR data being detected, determining if the detected IR data is valid IR remote control signal data;
wherein sampling the IR remote control signal data is carried out in response to the detected IR data being valid IR remote control signal data.

3. The method of claim 1 wherein:
sampling the IR remote control signal data to form an electrical signal includes grouping IR remote control signal samples into a data packet; and
sending the electrical signal to the source device includes sending the data packet to the source device.

4. The method of claim 1, further comprising:
at the source device, receiving the electrical signal; and
controlling the source device in accordance with the IR remote control signal data represented by the electrical signal.

5. The method of claim 4 wherein receiving the electrical signal includes determining if the electrical signal is corrupted, and in response to the electrical signal not being corrupted, the method further comprises sending an acknowledgment to the sink device via the forward channel.

6. The method of claim 5 wherein in response to the remote control data packet being corrupted, no acknowledgment is sent.

7. The method of claim 4 wherein controlling the source device further comprises regenerating the IR remote control signal data.

8. The method of claim 1, the method further comprising:
sending an acknowledgment to the sink device via the forward channel, so as to acknowledge receipt of the electrical signal at the source device;
at the sink device, determining whether an acknowledgment has been received within a pre-set time limit; and
in response to no acknowledgment being received within the pre-set time limit, re-sending the electrical signal.

9. The method of claim 8, the method further comprising:
determining if a timeout has occurred;
in response to a timeout, discarding the IR remote control signal data; and
in response to no timeout, repeating re-sending the electrical signal until either an acknowledgment is timely received or a timeout occurs.

10. The method of claim 1, the method further comprising:
determining whether an end of remote control data signal has been received; and
in response to no end of remote control data signal being received, repeating the sampling and sending.

11. The method of claim 1 wherein sampling the IR remote control signal data to form an electrical signal further includes:
recognizing a format associated with the IR remote control signal data; and
extracting command data included in the IR remote control signal data specified by the format;
wherein the command data is sampled to form the electrical signal.

12. The method of claim 1, further comprising:
at the source device, receiving the electrical signal;
recognizing a remote control signal format associated with the electrical signal; and
rebuilding a remote control signal pursuant to the format.

13. The method of claim 1, further comprising:
at the source device, receiving the electrical signal;
rebuilding a remote control signal pursuant to a known remote control signal format; and
providing the remote control signal to control circuitry of the source device, or converting the remote control signal to an IR signal and providing the IR signal to control circuitry of the source device.

14. A method for communicating remote control information in a multimedia communication system including a source device and a sink device that are communicatively coupled by a serial communication link that includes a forward channel and a backward channel, comprising:
at the sink device, detecting infrared (IR) data;
determining if the detected IR data is valid IR remote control signal data for the source device;
in response to the detected IR data being valid IR remote control signal data, sampling the IR remote control signal data;
grouping IR remote control signal samples into a data packet; and
sending the remote control data packet to the source device via the backward channel, wherein the forward channel can simultaneously carry payload data from the source device to the sink device;
wherein the backward channel is implemented using a single fiber optic cable or a wireless transmission, and the forward channel is implemented using the same single fiber optic cable as the backward channel or an optical wireless transmission.

15. The method of claim 14, further comprising:
at the source device, receiving the remote control data packet; and
controlling the source device in accordance with the IR remote control signal data represented by the remote control data packet.

16. The method of claim 15 wherein receiving the remote control data packet includes determining if the received remote control data packet is corrupted, and in response to the remote control data packet not being corrupted, the method further comprises sending an acknowledgment packet to the sink device via the forward channel, and in response to the remote control data packet being corrupted, no acknowledgment packet is sent.

17. The method of claim 15 wherein controlling the source device further comprises regenerating the IR remote control signal data.

18. The method of claim 14, the method further comprising:
sending an acknowledgment packet to the sink device via the forward channel, so as to acknowledge receipt of the remote control data packet at the source device;
at the sink device, determining whether an acknowledgment packet has been received within a pre-set time limit; and
in response to no acknowledgment packet being received within the pre-set time limit, re-sending the remote control data packet.

19. The method of claim 14, the method further comprising:
determining whether an end of remote control data signal has been received; and
in response to no end of remote control data signal being received, repeating the sampling, grouping, and sending.

20. A system for communicating remote control information between a source device and a sink device that are communicatively coupled by a serial communication link that includes a forward channel and a backward channel, the system comprising:
a sink-side infrared (IR) detector for detecting IR remote control signal data for the source device;
a sink-side control processor for sampling the IR remote control signal data to form an electrical signal; and
a sink-side transmitter for sending the electrical signal to the source device via the backward channel, wherein the forward channel can simultaneously carry payload data from the source device to the sink device;
wherein the backward channel is implemented using a single fiber optic cable or a wireless transmission, and the forward channel is implemented using the same single fiber optic cable as the backward channel or an optical wireless transmission.

21. The system of claim 20, further comprising:
a source-side receiver for receiving the electrical signal; and
a source-side remote control process for controlling the source device in accordance with the IR remote control signal data represented by the electrical signal.

22. The system of claim 20, the system further comprising:
a source-side transmitter for sending an acknowledgment to the sink device via the forward channel, so as to acknowledge receipt of the electrical signal at the source device;
wherein the sink-side control processor is further configured for determining whether an acknowledgment has been received within a pre-set time limit, and in response to no acknowledgment being received within the pre-set time limit, for causing the sink-side transmitter to re-send the electrical signal.

23. The system of claim 20 wherein the sink-side control processor is further configured for determining whether an end of remote control data signal has been received, and in response to no end of remote control data signal being received, for causing the sampling and sending to be repeated.

24. The system of claim 20 wherein the sink-side control processor is further adapted to recognize a format associated with the IR remote control signal data, and to extract command data included in the IR remote control signal data specified by the format, wherein the sink-side control processor samples the command data to form the electrical signal.

25. The system of claim 20, further comprising:
a source-side receiver for receiving the electrical signal; and
a source-side remote control process for recognizing a remote control signal format associated with the electrical signal, and rebuilding a remote control signal pursuant to the format.

26. The system of claim 20, further comprising:
a source-side receiver for receiving the electrical signal; and
a source-side remote control process for rebuilding a remote control signal pursuant to a known remote control signal format, and providing the remote control signal to control circuitry of the source device.

27. The system of claim 20, further comprising:
a source-side receiver for receiving the electrical signal; and
a source-side remote control process for rebuilding a remote control signal pursuant to a known remote control signal format, converting the remote control signal to a modulated IR signal, and providing the IR signal to control circuitry of the source device.

28. The system of claim 20 wherein parameters the modulated IR signal are user-programmable.
